(19) United States
(12) Patent Application Publication
(10) Pub. No.: US 2009/0300484 A1
(43) Pub. Date: Dec. 3, 2009

(54) SYSTEM AND METHOD FOR LOCAL MODIFICATION OF REMOTELY SUBMITTED DOCUMENT PROCESSING JOBS

(76) Inventors: Kenneth J. Stephenson, San Clemente, CA (US); Harpreet Singh, Orange, CA (US); Marianne L. Kodimer, Huntington Beach, CA (US); Louis Ormond, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/132,298

(22) Filed: Jun. 3, 2008

(51) Int. Cl. G06F 17/00

(52) U.S. Cl. 715/238

(57) ABSTRACT

The subject application is directed to rendering a remotely submitted document processing job using secondary job processing parameters specified at the rendering device. Electronic document data, associated identification data, and initial instruction data is received via a remote client interface. Location data of a selected rendering device is received via the remote interface, and the received job data is stored in a data storage associated with the device. The device's local interface receives login data, which is tested against the identification data. A display is selectively generated of the instruction and document data based on the testing output. Modified instruction data is received via the local interface relative to the initial instruction data. The costs for rendering the document data via the device are then calculated and displayed on the local interface. Following receipt of approval data via the local interface, a rendering operation is commenced on the document data.

### BACKGROUND OF THE INVENTION

The subject application is directed generally to remote rendering of electronic documents. The application is particularly applicable to remote submission of fee-based document processing jobs for which changes may be made by an end user at a rendering location prior to completion of a requested job rendering operation.

In the increasingly mobile and data connected society, many people will generate electronic documents to be rendered at a future time by a rendering device. Such rendering devices include printers, copiers, facsimile devices, or devices having more than one of these functions. Devices having more than one electronic document function are often referred to as multifunction peripherals (MFPs) or multifunction devices (MFDs).

Electronic documents, such as word processing files, image files, drawing files, spreadsheets, slides, or the like, are frequently created, captured or edited by intelligent devices. Such devices include workstations, personal digital assistants (PDAs), or other computer-based devices, such as desktop computers, notebook computers, smart phones, and the like. Often document rendering devices are not readily available, such as when documents are processed on a device without an associated printer, or in situations where a number of copies needed or finished document characteristics are best left to remotely located devices. In still other situations, a document may be transmitted to a site where tangible renderings are needed, but it is inconvenient or otherwise undesirable to carry the required documents to a particular location.

End users suitably specify targeted locations for document rendering. Such locations include printing kiosks, copy centers, satellite offices, client offices, remote printers, or the like. Many such locations will complete a requested job rendering operation for a fee. Fees are frequently quoted on a price-per-page, or price-per-copy basis.

Once a job is submitted for remote rendering, along with remotely specified parameters, a user must accept the rendering specified when a job is submitted. In many instances, the job has already been completed at a remote location, and rendered documents are awaiting pickup.

### SUMMARY OF THE INVENTION

In accordance with one embodiment of the subject application, there is provided a system and method for remote rendering of electronic documents.

Further, in accordance with one embodiment of the subject application there is provided a system and method for remote submission of fee-based document processing jobs for which changes may be made by an end user at a rendering location prior to completion of a requested job rendering operation.

Still further, in accordance with one embodiment of the subject application, there is provided a system and method for rendering a remotely submitted document processing job using secondary job processing parameters specified at the rendering device. Electronic document data comprising at least one electronic document for which rendering is desired, identification data associated with the electronic document data, initial document processing instruction data corresponding to a desired document processing operation associated with the electronic document data, and location data corresponding to a location of a selected document rendering device are received via a remote thin client interface. The electronic document data, identification data, and processing instruction data is then stored in a data storage associated with the selected document rendering device, received electronic document data, identification data, and processing instruction data. Login data is received via a local interface proximately associated with the document rendering device and tested against identification data. A display corresponding to instruction data and electronic document data in the data storage is generated in accordance with an output of the testing. Modified document processing instruction data corresponding to a modified document processing operation associated with the electronic document data relative to initial document processing instruction data is received via the local interface. A cost of completion of a rendering of electronic document data via the document rendering device is calculated in accordance with received modified document processing instruction data and such cost is displayed via the local interface. Approval data is received, via the local interface, corresponding to an acceptance of a cost associated with completion of a rendering of electronic document data via the document rendering device, which cost corresponds to the output of the cost calculation and a document rendering operation on the electronic document data is commenced in accordance with received approval data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for rendering a remotely submitted document processing job using secondary job processing parameters specified at the rendering device according to one embodiment of the subject application;

FIG. 2 is a block diagram illustrating controller hardware for rendering a remotely submitted document processing job using secondary job processing parameters specified at the rendering device according to one embodiment of the subject application;

FIG. 3 is a functional diagram illustrating the controller for use in the system for rendering a remotely submitted document processing job using secondary job processing parameters specified at the rendering device according to one embodiment of the subject application;

FIG. 4 is a diagram illustrating a workstation for use in the system for rendering a remotely submitted document processing job using secondary job processing parameters specified at the rendering device according to one embodiment of the subject application;

FIG. 5 is a diagram illustrating a workstation for use in the system for rendering a remotely submitted document processing job using secondary job processing parameters specified at the rendering device according to one embodiment of the subject application;

FIG. 6 is a flowchart illustrating a method for rendering a remotely submitted document processing job using secondary job processing parameters specified at the rendering device according to one embodiment of the subject application; and

FIG. 7 is a flowchart illustrating a method for rendering a remotely submitted document processing job using secondary job processing parameters specified at the rendering device according to one embodiment of the subject application.

### DETAILED DESCRIPTION OF THE PREFERRED EMBODIMENT

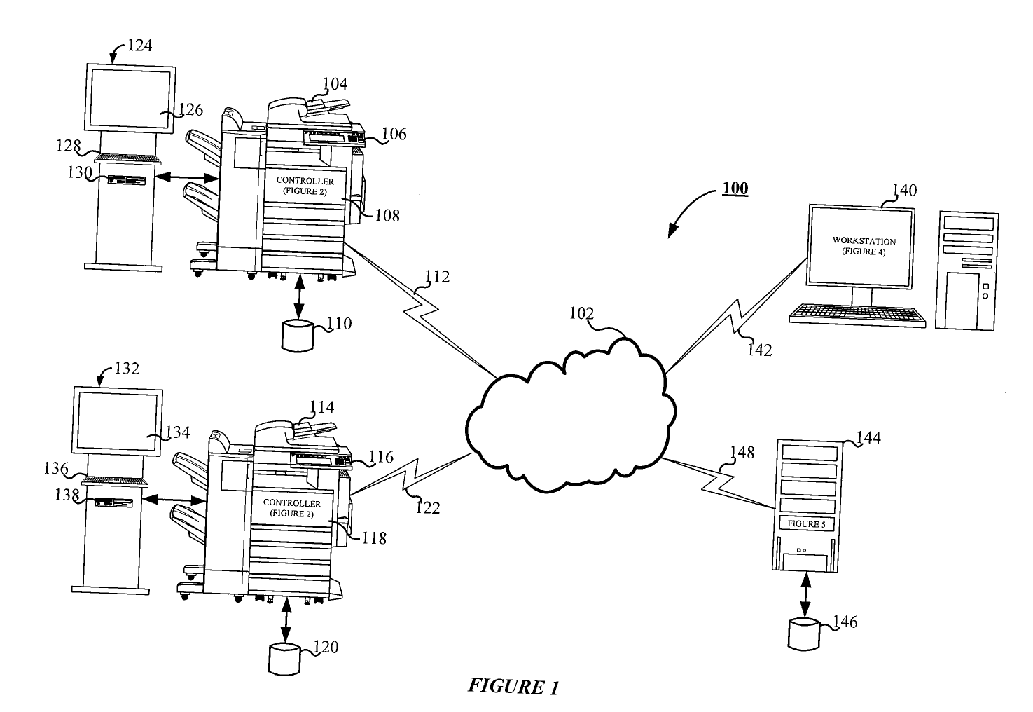

The subject application is directed to a system and method for remote rendering of electronic documents. In particular, the subject application is directed to a system and method for remote submission of fee-based document processing jobs for which changes may be made by an end user at a rendering location prior to completion of a requested job rendering operation. More particularly, the subject application is directed to a system and method for rendering a remotely submitted document processing job using secondary job processing parameters specified at the rendering device. It will become apparent to those skilled in the art that the system and method described herein are suitably adapted to a plurality of varying electronic fields employing remote processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for rendering a remotely submitted document processing job using secondary job processing parameters specified at the rendering device in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes one or more document rendering devices, depicted in FIG. 1 as the document rendering devices 104, 114, and 124. As shown in FIG. 1, the document rendering devices 104 and 114 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering devices 104 and 114 are suitably adapted to provide remote document processing services to external or network devices. Preferably, the document rendering devices 104 and 114 include hardware, software, and any suitable combination thereof, configured to interact with an associated user, a networked device, or the like.

According to one embodiment of the subject application, the document rendering devices 104 and 114 are suitably equipped to receive a plurality of portable storage media, including, without limitation, Firewire drive, USB drive, SD, MMC, XD, Compact Flash, Memory Stick, and the like. In the preferred embodiment of the subject application, the document rendering devices 104 and 114 further include associated user interfaces 106 and 116, such as a touch-screen, LCD display, touch-panel, alpha-numeric keypad, or the like, via which an associated user is able to interact directly with the document rendering devices 104 and 114. In accordance with the preferred embodiment of the subject application, the user interfaces 106 and 116 are advantageously used to communicate information to associated users and receive selections from such associated users.

The skilled artisan will appreciate that the user interfaces 106 and 116 comprise various components, suitably adapted to present data to associated users, as are known in the art. In accordance with one embodiment of the subject application, the user interfaces 106 and 116 comprise a display, suitably adapted to display one or more graphical elements, text data, images, or the like, to an associated user, receive input from the associated user, and communicate the same to a backend component, such as controllers 108 and 118, as explained in greater detail below. Preferably, the document rendering devices 104 and 114 are communicatively coupled to the computer network 102 via suitable communications links 112 and 122. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

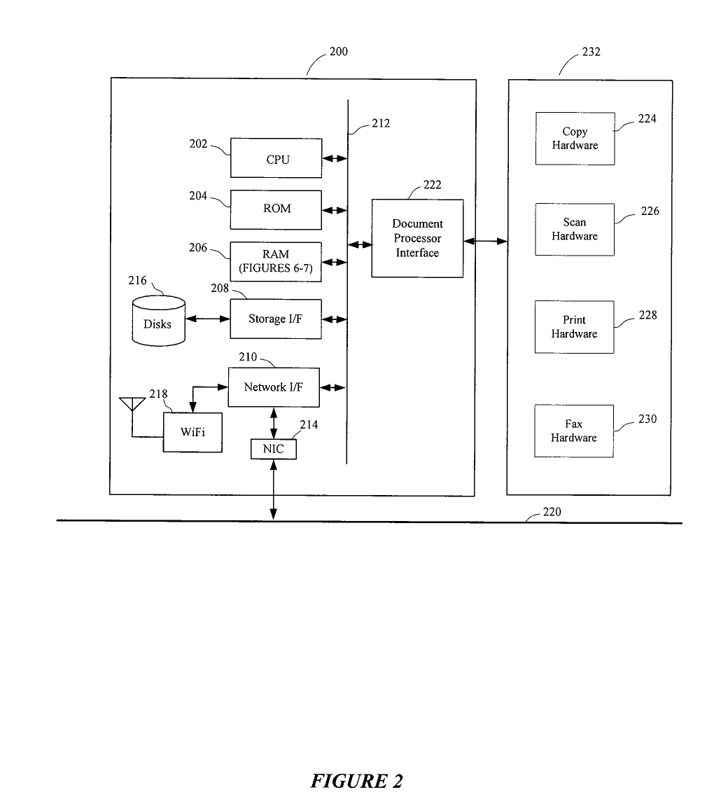

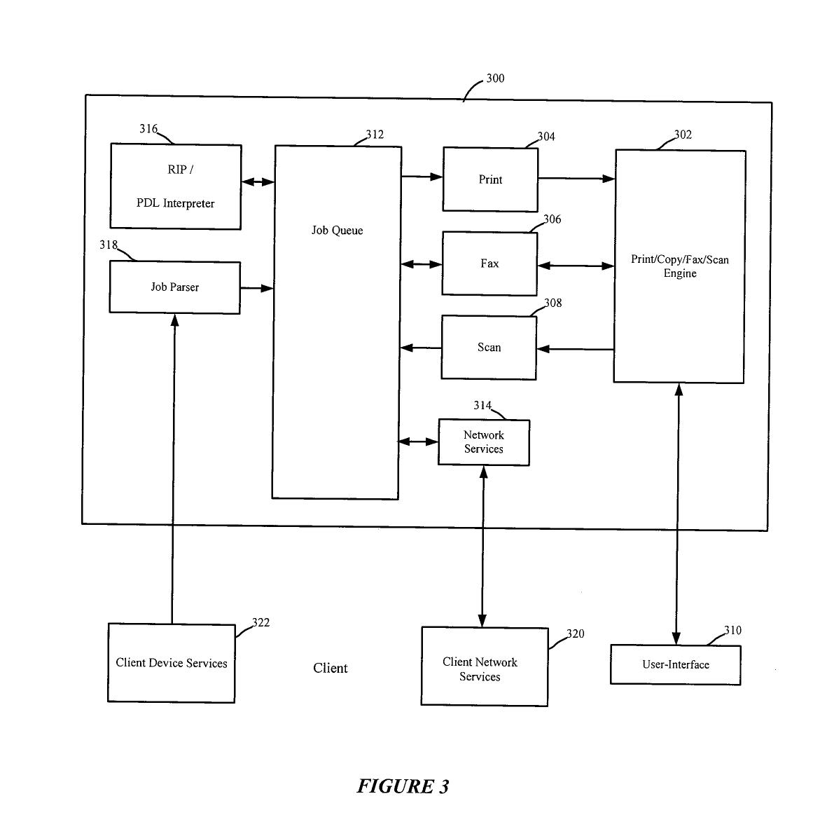

In accordance with one embodiment of the subject application, the document rendering devices 104 and 114 further incorporate a backend component, designated as the controllers 108 and 118, suitably adapted to facilitate the operations of their respective document rendering devices 104 and 114, as will be understood by those skilled in the art. Preferably, the controllers 108 and 118 are embodied as hardware, software, or any suitable combination thereof, configured to control the operations of the associated document rendering devices 104 and 114, facilitate the display of images via the user interfaces 106 and 116, direct the manipulation of electronic image data, and the like. For purposes of explanation, the controllers 108 and 118 are used to refer to any myriad of components associated with the document rendering devices 104 and 114, including hardware, software, or combinations thereof, functioning to perform, cause to be performed, control, or otherwise direct the methodologies described hereinafter. It will be understood by those skilled in the art that the methodologies described with respect to the controllers 108 and 118 are capable of being performed by any general purpose computing system, known in the art, and thus the controllers 108 and 118 are representative of such a general computing device and is intended as such when used hereinafter. Furthermore, the use of the controllers 108 and 118 hereinafter is for the example embodiment only, and other embodiments, which will be apparent to one skilled in the art, are capable of employing the system and method for rendering a remotely submitted document processing job using secondary job processing parameters specified at the rendering device of the subject application. The functioning of the controllers 108 and 118 will better be understood in conjunction with the block diagrams illustrated in FIGS. 2 and 3, explained in greater detail below.

Communicatively coupled to the document rendering devices 104 and 114 are data storage devices 110 and 120. In accordance with the preferred embodiment of the subject application, the data storage devices 110 and 120 are any mass storage device known in the art including, for example and without limitation, magnetic storage drives, a hard disk drive, optical storage devices, flash memory devices, or any suitable combination thereof. In the preferred embodiment, the data storage devices 110 and 120 are suitably adapted to store document data, image data, electronic database data, or the like. It will be appreciated by those skilled in the art that while illustrated in FIG. 1 as being a separate component of the system 100, the data storage devices 110 and 120 are capable of being implemented as internal storage components of the document rendering devices 104 and 114, components of the controllers 108 and 118, or the like, such as, for example and without limitation, an internal hard disk drive, or the like.

Illustrated in FIG. 1 are a first kiosk 124, communicatively coupled to the first document rendering device 104, and in effect, the computer network 102, and a second kiosk 132, communicatively coupled to the second document rendering device 114, and in effect, the computer network 102. It will be appreciated by those skilled in the art that the kiosks 124 and 132 are capable of being implemented as separate components of the respective document rendering devices 104 and 114, or as integral components thereof. Use of the kiosks 124 and 132 in FIG. 1 are for example purposes only, and the skilled artisan will appreciate that the subject application is capable of implementation without the use of kiosks 124 and 132. In accordance with one embodiment of the subject application, the kiosks 124 and 132 include respective displays 126 and 134 and user input devices 128 and 136. As will be understood by those skilled in the art the kiosks 124 and 132 are capable of implementing a combination user input device/display, such as a touch screen interface. According to one embodiment of the subject application, the kiosks 124 and 132 are suitably adapted to display selected advertisements to prospective customers, prompts to an associated user, receive instructions from the associated user, receive payment data, receive selection data from the associated user, and the like. Preferably, the kiosks 124 and 132 include a magnetic card reader, conventional bar code reader, or the like, suitably adapted to receive and read payment data from a credit card, coupon, debit card, or the like.

The system 100 of FIG. 1 also includes portable storage device readers 130 and 138, coupled to the kiosks 124 and 132 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

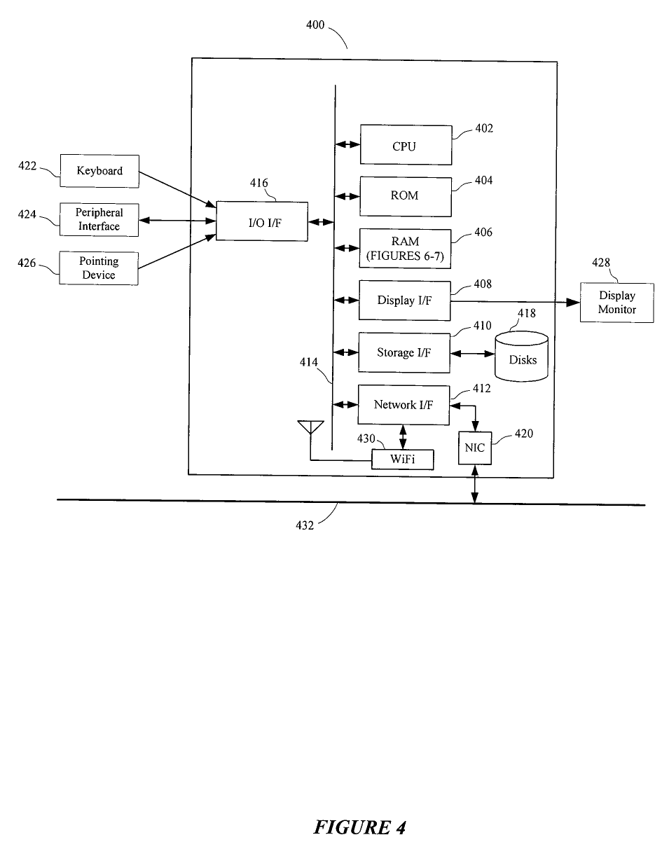

The system 100 illustrated in FIG. 1 further depicts a workstation 140, in data communication with the computer network 102 via a communications link 142. It will be appreciated by those skilled in the art that the workstation 140 is shown in FIG. 1 as a computer workstation for illustration purposes only. As will be understood by those skilled in the art, the workstation 140 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 142 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 140 is suitably adapted to receive and modify image data, generate electronic document data, communicate document processing jobs, perform color calculations and conversions, generate display data, generate output data, or the like, to the document rendering devices 104 and 114, or any other similar device coupled to the computer network 102. In accordance with one embodiment of the subject application, the workstation 140 suitably includes a thin client interface, such as a web-browser, suitably adapted for communication with a hosted web-portal, a remote link with the document rendering devices 104 and 114, or the like. The functioning of the workstation 140 will better be understood in conjunction with the block diagrams illustrated in FIG. 4, explained in greater detail below.

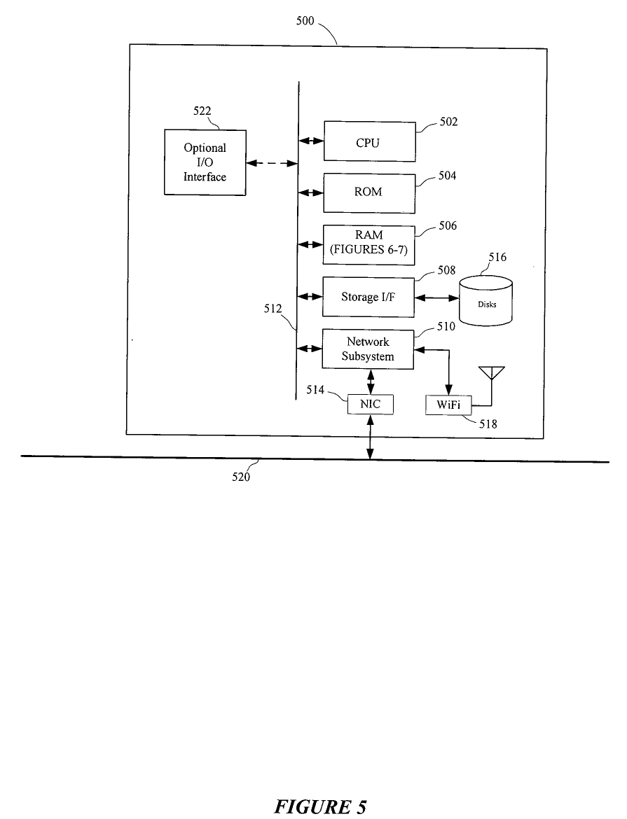

In accordance with one embodiment of the subject application, the system 100 of FIG. 1 includes a backend server 144 suitably adapted to facilitate the communication of document processing jobs from the workstation 140 to the document rendering devices 104 and 114, facilitate receipt of payment data, temporarily store job data, maintain user identification/account information, and the like. Preferably, the server 144 is communicatively coupled to the computer network 102 via a suitable communications link 148. It will be appreciated by those skilled in the art that the server 144 comprises hardware, software, and combinations thereof suitably adapted to provide one or more services, web-base applications, storage options, and the like, to networked devices. In accordance with one embodiment of the subject application, the server 144 includes various components, implemented as hardware, software, or a combination thereof, for managing the retention of electronic data, performing searches, storing advertisements, storing account information, storing billing information, retrieval of documents, and the like, which are accessed via the computer network 102. The communications link 148 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components described with respect to the server 144 hereinafter are capable of implementation on any computing device coupled to the computer network 102 and functioning as a backend server. The functioning of the server 144 will better be understood in conjunction with the block diagrams illustrated in FIG. 5, explained in greater detail below.

Communicatively coupled to the server 144 is the data storage device 146. In accordance with the preferred embodiment of the subject application, the data storage device 146 is any mass storage device, or plurality of such devices, known in the art including, for example and without limitation, magnetic storage drives, a hard disk drive, optical storage devices, flash memory devices, or any suitable combination thereof. In the an example embodiment, the data storage device 146 is suitably adapted to store processing job data, location data, software updates, update lists, electronic database data, document data, image data, location data, advertisement data, account data, user data, and the like. It will be appreciated by those skilled in the art that while illustrated in FIG. 1 as being a separate component of the system 100, the data storage device 146 is capable of being implemented as internal storage component of the server 144, or the like, such as, for example and without limitation, an internal hard disk drive, or the like.

Turning now to FIG. 2, illustrated is a representative architecture of a suitable backend component, i.e., the controller 200, shown in FIG. 1 as the controllers 108 and 118, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering devices 104 and 114, which includes the controller 200 of FIG. 2, (shown in FIG. 1 as the controllers 108 and 118) as an intelligent subsystem associated with a document rendering device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the workstation 140, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

Turning now to FIG. 5, illustrated is a representative architecture of a suitable server 500, shown in FIG. 1 as the server 144, on which operations of the subject system are completed. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration, and other routines or data used for operation of the server 500.

Also included in the server 500 is random access memory 506, suitably formed of dynamic random access memory, static random access memory, or any other suitable, addressable memory system. Random access memory provides a storage area for data instructions associated with applications and data handling accomplished by the processor 502.

A storage interface 508 suitably provides a mechanism for volatile, bulk or long term storage of data associated with the server 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the server 500 to communicate to other devices. The network interface subsystem 510 suitably interfaces with one or more connections with external devices to the server 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network subsystem 510 is suitably accomplished via a bus data transfer mechanism, such as illustrated by bus 512.

Suitable executable instructions on the server 500 facilitate communication with a plurality of external devices, such as workstations, document rendering devices, other servers, or the like. While, in operation, a typical server operates autonomously, it is to be appreciated that direct control by a local user is sometimes desirable, and is suitably accomplished via an optional input/output interface 522 as will be appreciated by one of ordinary skill in the art.

In operation, electronic document data is first received via a remote thin client interface that comprises at least one electronic document for which rendering is desired. Identification data associated with the electronic document data is then received via the remote thin client interface. Initial document processing instruction data is then received via the remote client interface corresponding to a desired document processing operation associated with the electronic document data. Location data corresponding to the location of a selected document rendering device is then received via the remote thin client interface. The received electronic document data, identification data, and processing instruction data are then stored in a data storage associated with the selected rendering device. A local interface proximately associated with the document rendering device then receives login data. The login data is then tested against the received identification data and a display is then selectively generated corresponding to the instruction data and the electronic document data in the data storage based upon the testing output. Modified document processing instruction data is then received via the local interface corresponding to a modified document processing operation associated with the electronic document data relative to the initial document processing instruction data. A cost of completion of a rendering of the electronic document data via the rendering device is then calculated in accordance with the received modified instruction data. A display is then generated via the local interface corresponding to the calculated cost. Approval data is then received via the local interface corresponding to the acceptance of the calculated cost for completion of the rendering by the rendering device. Thereafter, a document rendering operation is commenced on the electronic document data in accordance with received approval data.

In accordance with one example embodiment of the subject application, electronic document data is received by the server 144 from a remote thin client interface. Preferably, a user associated with the workstation 140 submits and electronic document for processing by a document rendering device via a thin client interface operative thereon. According to one embodiment of the subject application, the workstation 140 communicates the electronic document data to the backend server 144 via the thin client interface, e.g. a web portal hosted by the server 144. The skilled artisan will appreciate that the subject application enables the workstation 140 to communicate data directly to a desired document rendering device 104 or 114 via the computer network 102, as well as to communicate the data to the server 144, whereupon a user is able to access the data from a suitable document rendering device 104 or 114. According to a further embodiment of the subject application, the system 100 includes a plurality of document rendering devices (not shown), in addition to document rendering devices 104 and 114, communicatively coupled to the computer network 102 whereby a user is able to select at least one of the document rendering devices for output of a desired electronic document.

Identification data is then received via the thin client interface of the workstation 140 associated with the electronic document data. In accordance with one embodiment of the subject application, the identification data includes data unique to the electronic document, data representative of the user associated therewith, and the like. Initial document processing instruction data is then received via the thin client interface of the workstation 140 corresponding to desired document processing operations associated with the electronic document. It will be appreciated by those skilled in the art that suitable instructions include, for example and without limitation, document processing job options, finishing options, number of copies, destination folder, recipient information, and other instructions associated with the processing/rendering of an electronic document. Preliminary payment data is then received via the thin client interface of the workstation 140 corresponding to a method of payment for the rendering of the electronic document in accordance with the initial document processing instructions. Those skilled in the art will appreciate that suitable forms of payment include, for example and without limitation, credit card, prepaid card, account billing information, and the like.

Location data of a selected document rendering device, e.g. the document rendering device 104 or 114, is then received via the thin client interface of the workstation 140 corresponding to a desired document rendering device 104 or 114 at which the electronic document is to be processed in accordance with the received instruction data. In accordance with one embodiment of the subject application, the workstation 140 communicates with the server 144 so as to ascertain the available document rendering devices 104 and 114 for output thereto. In such an embodiment, the forgoing data is received by the server 144 from the workstation 140 and stored in the data storage 146 associated therewith. Preferably, the electronic document data, the identification data, and the initial processing instruction data are stored in a data storage associated with the selected document rendering device 104 or 114. That is, in addition to or in place of storing the received data on the data storage device 146 associated with the server 144, the data storage device 110 of the document rendering device 104 or device 120 of the document rendering device 114, depending on the selection by the user, is equally capable of storing such data.

The user associated with the submitted electronic document data then approaches a desired document rendering device 104 or 114 for output of the document data thereby. Thus, for example purposes only, the user approaches the first document rendering device 104 and provides login data via a local interface associated with the rendering device 104. That is, the controller 108 or other suitable component associated with the document rendering device 104 receives login data from the associated user via the user interface 106, the kiosk 124, e.g. the user input device 128, the touch screen display 126, or other suitable interface component. The controller 108 or other suitable component associated with the document rendering device 104 then tests the login data against identification data stored in the data storage associated with the document rendering device 104, i.e. the server 144, the data storage device 110, or the like. In accordance with one embodiment of the subject application, the controller 108 searches the data storage, e.g. server 144 or the data storage device 110, for submitted electronic document data having associated identification data corresponding to the received login data. When no match is located by the controller 108 or other suitable component associated with the document rendering device 104, the controller 108 enables normal operations of the document rendering device 104 for the user, i.e. it does not retrieve any previously submitted document processing jobs.

Upon a determination of a match, the electronic document data is retrieved and a display is generated via the user interface 106, the touch screen display, or the like, corresponding to the submitted electronic document data and associated instruction data. The user is then presented via the user interface 106, kiosk 124, or the like, with the ability to modify the previously submitted document processing instruction data so as to adjust or change the processing operations associated with the electronic document.

When no modifications to the previously received document processing instruction data have been received, the controller 108 or other suitable component associated with the document rendering device 104 calculates the cost of completing the rendering of the submitted electronic document data in accordance with the previously received document processing instructions. The calculated cost is then displayed via the user interface 106, the touch screen display 126, or other suitable display component associated with the document rendering device 104. The user is then able to change the payment method. That is, the user is able to change credit cards, input a different account number, change to cash, or the like. Modified payment data is received by the controller 108 or other suitable component associated with the document rendering device 104 in the event that the user desires to provide a different payment method. Following receipt of the payment data, either the original payment data or modified payment data, the user is prompted to approve the displayed cost calculation via the user interface 106, the kiosk 124, or the like. After receipt of the approval data, the document rendering device 104 commences performance of the document rendering operation in accordance with the previously submitted document processing instruction data. Payment is thereafter secured for the performance of the document processing operation, e.g. a credit card is charged, an account is billed, or the like.

When modifications to the previously submitted document processing instructions are desired by the associated user, modifications are input via the use interface 106, the touch screen display 126, the user input device 128, or other suitable component associated with the document rendering device 104. Suitable modifications include changes to the finishing options, such as, for example and without limitation, color rendering, stapling, collation, medium size, medium stock, simplex, duplex, n-up rendering, binding, and the like. Following receipt of the modified document processing instructions, the controller 108 or other suitable component associated with the document rendering device 104 calculates the cost associated with the rendering of the electronic document in accordance with the modified document processing instruction data. The cost is then displayed to the user via the user interface 106, the touch screen display 126, or other suitable display component associated with the document rendering device 104.

The user is then presented with the option of changing the payment method via the user input device 128, the user interface 106, the touch screen display 126, or the like. In the event that the user does not desire to modify the payment method, the user is prompted to accept the displayed costs. Following acceptance, the document rendering device 104 commences rendering operations in accordance with the received modified document processing instructions and secures payment from the user, e.g. charging the credit card, billing the account, or the like. Similarly, when the user submits an alternate payment method, the alternate payment method is instead used to cover the cost associated with the performance of the document rendering operation in accordance with the received modified document processing instructions.

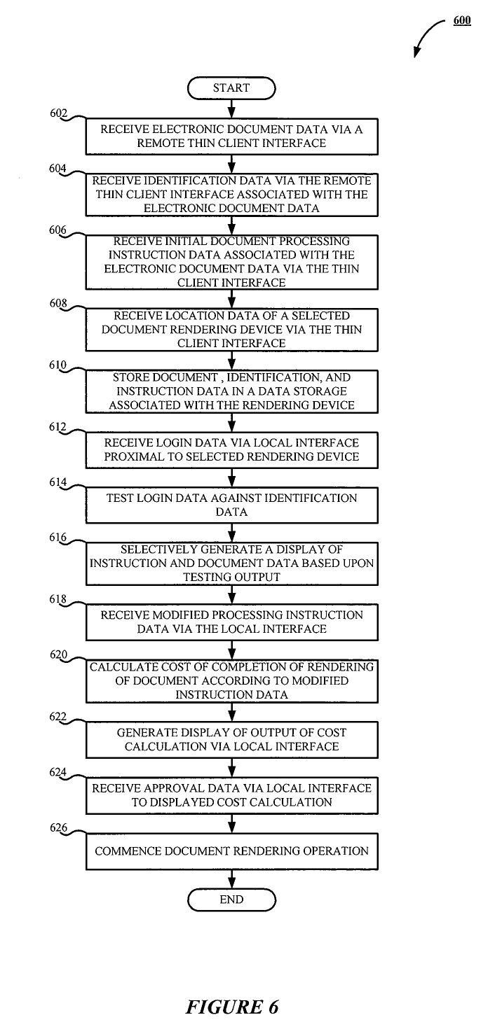

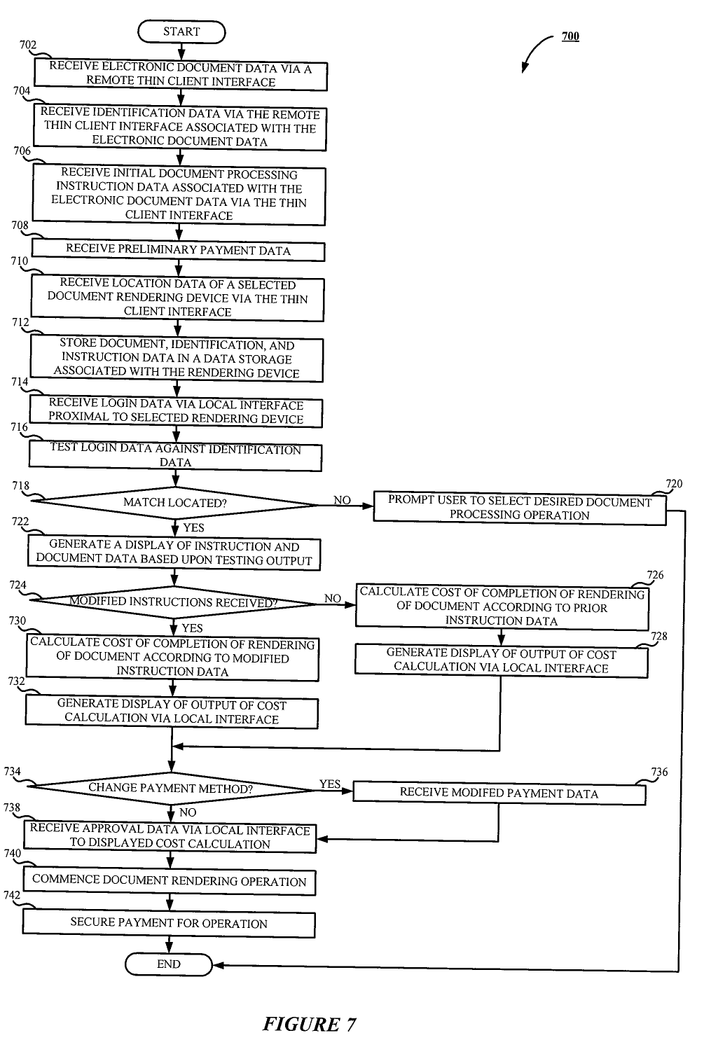

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for rendering a remotely submitted document processing job using secondary job processing parameters specified at the rendering device in accordance with one embodiment of the subject application. Beginning at step 602, electronic document data is first received via a remote thin client interface comprising at least one electronic document for which rendering is desired. In accordance with one embodiment of the subject application, the thin client interface is suitably accessed by an associated user via the computer workstation 140, as will be understood by those skilled in the art. The skilled artisan will appreciate that a suitable thin client interface includes, for example and without limitation, a web-browser such as INTERNET EXPLORER, OPTERA, MOZILLA, SAFARI, or the like.

At step 604, identification data associated with the electronic document data is then received via the remote thin client interface. Suitable identification data includes, for example and without limitation, user identification information, password information, unique document identification, and the like. Initial document processing instruction data is then received at step 606 via the remote thin client interface corresponding to a desired document processing operation associated with the received electronic document data. The skilled artisan will appreciate that such document processing instruction data is capable of including, for example and without limitation, a type of document processing operation, a document processing parameter comprising a number of copies or finishing parameters, and the like. Suitable finishing parameter include, for example and without limitation, color rendering, stapling, collation, medium size, medium stock, simplex, duplex, n-up rendering, binding, and the like.

At step 608, location data is received via the remote thin client interface associated with the workstation 140 corresponding to a selected document rendering device 104 or 114. According to one embodiment of the subject application, the user associated with the workstation 140 is able to select a desired document rendering device 104 or 114 via the thin client interface resident thereon. The received electronic document data, identification data, and processing instruction data are then stored at step 610 in a data storage associated with the selected rendering device 104 or 114. For example, when the first document rendering device 104 is selected via the location data, the data storage device 110 is used for storage of the received data. In another example embodiment, the server 144 stores the received data in the data storage device 146, which preferably stores the data in association with the selected document rendering device 104.

At step 612, login data is received via a local interface proximately associated with the document rendering device 104 or 114. That is, the user interface 106 or kiosk 124 associated with the first document rendering device 104 receives login data from the associated user, or the user interface 116 or kiosk 132 associated with the second document rendering device 114 receives the login data. At step 614, the controller 108 or 118 or other suitable component associated with the document rendering device 104 or 114 tests the received login data against the identification data stored in the associated data storage 110 or 120.

At step 616, a display is then selectively generated on the local interface (e.g. the user interface 106, 116, or touch screen display 126, 134) corresponding to the instruction data and the electronic document data in the data storage 110 or 120 based upon the testing output. Modified document processing instruction data is then received at step 618 via the local interface 106, 116, 124, or 132 corresponding to a modified document processing operation associated with the electronic document data relative to the initial document processing instruction data. For example, a user is able to modify the previously submitted finishing parameters, so that color rendering is to be performed, stapling is not to be performed, n-up rendering is to be performed, or the like. At step 620, the controller 108, 118 or other suitable component associated with the document rendering device 104 or 114 then calculates a cost of completing a rendering of the electronic document data based upon the received modified instruction data. A display is then generated at step 622 via the local interface 106, 116, 126, or 134 corresponding to the calculated cost. Approval data is then received from the associated user via the local interface 106, 116, 124, or 132 corresponding to the acceptance of the calculated cost for completion of the rendering by the document rendering device 104 or 114 at step 624. At step 626, a document rendering operation is commenced on the electronic document data in accordance with received approval data by the selected document rendering device 104 or 114.

Referring now to FIG. 7, there is shown a flowchart 700 illustrating a method for rendering a remotely submitted document processing job using secondary job processing parameters specified at the rendering device in accordance with one embodiment of the subject application. For example purposes only, reference is made hereinafter to the computer first document rendering device 104 being selected in accordance with the methodology set forth in FIG. 7. The skilled artisan will appreciate that any suitable document rendering device 104 or 114 coupled to the computer network 102 is equally capable of being selected in accordance with the methodology of FIG. 7 and the following description is therefore only intended as an example illustration of such methodology. The method of FIG. 7 begins at step 702, whereupon electronic document data is received by the server 144 from a remote thin client interface. In accordance with one embodiment of the subject application, a user associated with the workstation 140 submits an electronic document for processing by a document rendering device via a thin client interface operative thereon. According to one embodiment of the subject application, the workstation 140 communicates the electronic document data to the backend server 144 via the thin client interface. That is, a suitable thin client interface, e.g. a web browser, accesses a web portal hosted by the server 144, via which the workstation 140 submits the electronic document data. It will be appreciated by those skilled in the art that the subject application also enables the workstation 140 to communicate data directly to a desired document rendering device 104 or 114 via the computer network 102, as well as to communicate the data to the server 144, whereupon a user is able to access the data from a suitable document rendering device 104 or 114.

At step 704, identification data is received via the thin client interface of the workstation 140 associated with the electronic document data. The skilled artisan will appreciate that the identification data includes data unique to the electronic document, data representative of the user associated therewith, and the like. Initial document processing instruction data is then received at step 706 via the thin client interface of the workstation 140 corresponding to desired document processing operations associated with the electronic document. Those skilled in the art will appreciate that suitable instructions include, for example and without limitation, document processing job options, finishing options, number of copies, destination folder, recipient information, and other instructions associated with the processing/rendering of an electronic document.

At step 708, preliminary payment data is received from the associated user via the thin client interface of the workstation 140 representing a selected method of payment for the rendering of the electronic document in accordance with the initial document processing instructions. Those skilled in the art will appreciate that suitable forms or methods of payment include, for example and without limitation, credit card, prepaid card, account billing information, and the like. At step 710, location data of a selected document rendering device 104 is then received via the thin client interface of the workstation 140 corresponding to a desired document rendering device 104 or 114 at which the electronic document is to be processed in accordance with the received instruction data.

The electronic document data, the identification data, the payment data, and the instruction data is then stored in a data storage associated with the selected document rendering device 104 or 114 at step 712. In accordance with one embodiment of the subject application, the workstation 140 communicates with the server 144 so as to ascertain the available document rendering devices 104 and 114 and the corresponding location thereof. In such an embodiment, the document, instructional, payment, and identification data received by the server 144 from the workstation 140 is stored in the data storage 146 in association with the selected document rendering device 104. That is, in addition to or in place of storing the received data on the data storage device 146 associated with the server 144 or the data storage device 110 of the document rendering device 104 is equally capable of storing such data.

At step 714, login data is received by the controller 108 or other suitable component associated with the document rendering device 104 from an associated user via the local interface corresponding thereto. That is, the user associated with the submitted electronic document data approaches the selected rendering device 104 and provides login data via the local interface associated with the rendering device 104. It will be understood by those skilled in the art that the local interface includes, for example and without limitation, the user interface 106, the kiosk 124, e.g. the user input device 128, the touch screen display 126, or other suitable interface component associated with the document rendering device 104.

At step 716, the controller 108 or other suitable component associated with the document rendering device 104 tests the login data against identification data stored in the data storage associated with the document rendering device 104, i.e. the server 144, the data storage device 110, or the like. A determination is then made at step 718 by the controller 108 whether a match has been located in accordance with the testing performed at step 716. In accordance with one embodiment of the subject application, the controller 108 or other suitable component associated with the document rendering device 104 searches the data storage, e.g. server 144 or the data storage device 110, for submitted electronic document data having associated identification data corresponding to the received login data. Upon a negative determination at step 718, flow proceeds to step 720, whereupon the user is prompted via the user interface 106 or the kiosk 124 to select a desired document processing operation and the methodology with respect to FIG. 7 terminates thereafter. Stated another way, in the event that no match is located by the controller 108 enables normal operations of the document rendering device 104 for the user, i.e. does not retrieve any previously submitted document processing jobs.

When it is determined at step 718 that a match has been located, flow proceeds to step 722. At step 722, a display is generated via the user interface 106, the touch screen display, or the like, corresponding to the submitted electronic document data and associated instruction data. Preferably, the controller 108 or other suitable component associated with the document rendering device 104 retrieves the electronic document data and associated instruction data from the associated data storage device 110, from the data storage device 146 associated with the server 144, or the like. A determination is then made at step 724 whether modified instruction data has been received from the associated user via the user interface 106, the touch screen display 126, the user input device 128, or the like. That is, the user is then presented with the option of modifying the previously submitted document processing instruction data so as to adjust or change the processing operations associated with the electronic document.

Upon a determination at step 724 that no modifications to the previously received document processing instruction data have been received, operations progress to step 726, whereupon the controller 108 or other suitable component associated with the selected document rendering device 104 calculates the cost of completing the rendering of the submitted electronic document data in accordance with the previously received document processing instructions. At step 728, the calculated cost is then displayed via the user interface 106, the touch screen display 126, or other suitable display component associated with the document rendering device 104.

A determination is then made at step 734 whether the user has changed the payment method. That is, a determination is made whether or not the user has changed the preliminary payment method, e.g. change credit cards, input a different account number, change to cash, or the like. When it is determined at step 734 that no change in the preliminary payment data is desired, operations proceed directly to step 738, as discussed below. Upon a determination at step 734 that the user desires to modify the payment data, flow proceeds to step 736. At step 736, modified payment data is received by the controller 108 or other suitable component associated with the document rendering device 104 from the user corresponding to a different payment method. At step 738, the user is prompted to approve the displayed cost calculation via the user interface 106, the kiosk 124, or the like. After receipt of the approval data, flow proceeds to step 740, whereupon the document rendering device 104 commences performance of the document rendering operation in accordance with the previously submitted document processing instruction data. Payment is then secured at step 742 for the performance of the document processing operation, e.g. a credit card is charged, an account is billed, or the like.

Returning to step 724, when one or more modifications to the previously submitted document processing instructions have been received from the associated user via the use interface 106, the touch screen display 126, the user input device 128, or other suitable component associated with the document rendering device 104, flow proceeds to step 730.

It will be appreciated by those skilled in the art that suitable modifications to the document processing instruction data include changes to the finishing options, such as, for example and without limitation, color rendering, stapling, collation, medium size, medium stock, simplex, duplex, n-up rendering, binding, and the like. At step 730, the controller 108 or other suitable component associated with the document rendering device 104 calculates the cost associated with the rendering of the electronic document in accordance with the modified document processing instruction data. The cost is then displayed to the user via the user interface 106, the touch screen display 126, or other suitable display component associated with the document rendering device 104 at step 732.

At step 734, the user is then presented with the option of changing the payment method via the user input device 128, the user interface 106, the touch screen display 126, or other suitable input means associated with the selected document rendering device 104. Upon a determination at step 734 that the user does not desire to modify the payment method, the user is prompted to accept the displayed costs at step 738. Following acceptance at step 738, flow proceeds to step 740, whereupon the document rendering device 104 commences rendering operations in accordance with the received modified document processing instructions. At step 742, the document rendering device 104, via the controller 108 or other suitable component associated therewith secures payment from the user, e.g. charging the credit card, billing the account, or the like.

Upon a determination at step 734 that an alternate form of payment is desired, flow proceeds to step 736, whereupon the user provides a different suitable payment method. Thereafter, flow proceeds to step 738, whereupon acceptance is received of the calculated cost associated with the performance of the document rendering operation in accordance with the received modified document processing instructions. Thereafter, the document rendering device 104 commences the performance of a rendering operation on the electronic document data in accordance with the modified document processing instructions at step 740. The payment for the performance of the rendering operation is then secured by the controller 108 or other suitable component associated with the document rendering device 104 at step 742 in accordance with the alternate payment method received from the associated user.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for rendering a remotely submitted document processing job using secondary job processing parameters specified at the rendering device comprising:
means adapted for receiving, via a remote thin client interface, electronic document data comprising at least one electronic document for which rendering is desired;
means adapted for receiving, via the remote thin client interface, identification data associated with the electronic document data;
means adapted for receiving, via the remote client interface, initial document processing instruction data corresponding to a desired document processing operation associated with the electronic document data;
means adapted for receiving, via the remote thin client interface, location data corresponding to a location of a selected document rendering device;
a data storage associated with the selected document rendering device, the data storage including means adapted for storing received electronic document data, identification data, and processing instruction data;
local interface means adapted for receiving login data, which local interface means is proximately associated with the document rendering device;
testing means adapted for testing received login data against identification data;
means adapted for selectively generating a display corresponding to instruction data and electronic document data in the data storage in accordance with an output of the testing means;
means adapted for receiving via the local interface means, modified document processing instruction data corresponding to a modified document processing operation associated with the electronic document data relative to initial document processing instruction data;
cost calculation means adapted for calculating a cost of completion of a rendering of electronic document data via the document rendering device in accordance with received modified document processing instruction data;
means adapted for generating a display, via the local interface means, corresponding to an output of the cost calculation means;
means adapted for receiving approval data, via the local interface means, corresponding to an acceptance of a cost associated with completion of a rendering of electronic document data via the document rendering device, which cost corresponds to the output of the cost calculation means; and
means adapted for commencing a document rendering operation on the electronic document data in accordance with received approval data.

2. The system of claim 1 further comprising means adapted for securing payment in accordance with a completed document rendering operation.

3. The system of claim 1 wherein the initial document processing data and the modified document processing data includes data corresponding to at least one document processing parameter comprising at least one of number of copies and document finishing parameters for the electronic document data.

4. The system of claim 3 wherein the document finishing data includes at least one of color rendering, stapling, collation, medium size, medium stock, simplex, duplex, and n-up rendering.

5. The system of claim 2 wherein payment data corresponding to a specified payment method for rendering of the electronic document is initially received via the local interface means.

6. The system of claim 2 wherein preliminary payment data corresponding to a specified payment method for rendering of the electronic document is received via the remote thin client interface.

7. The system of claim 6 wherein modified payment data corresponding to a modified form of payment for rendering of the electronic document is received via the local interface means.

8. A method for rendering a remotely submitted document processing job using secondary job processing parameters specified at the rendering device comprising the steps of:
receiving, via a remote thin client interface, electronic document data comprising at least one electronic document for which rendering is desired;
receiving, via the remote thin client interface, identification data associated with the electronic document data;
receiving, via the remote client interface, initial document processing instruction data corresponding to a desired document processing operation associated with the electronic document data;
receiving, via the remote thin client interface, location data corresponding to a location of a selected document rendering device;
storing, in a data storage associated with the selected document rendering device, received electronic document data, identification data, and processing instruction data;
receiving login data, via a local interface proximately associated with the document rendering device;
testing received login data against identification data;
selectively generating a display corresponding to instruction data and electronic document data in the data storage in accordance with an output of the testing;
receiving, via the local interface, modified document processing instruction data corresponding to a modified document processing operation associated with the electronic document data relative to initial document processing instruction data;
calculating a cost of completion of a rendering of electronic document data via the document rendering device in accordance with received modified document processing instruction data;
generating a display, via the local interface, corresponding to an output of the cost calculation;
receiving approval data, via the local interface, corresponding to an acceptance of a cost associated with completion of a rendering of electronic document data via the document rendering device, which cost corresponds to the output of the cost calculation; and
commencing a document rendering operation on the electronic document data in accordance with received approval data.

9. The method of claim 8 further comprising the step of securing payment in accordance with a completed document rendering operation.

10. The method of claim 8 wherein the initial document processing data and the modified document processing data includes data corresponding to at least one document processing parameter comprising at least one of number of copies and document finishing parameters for the electronic document data.

11. The method of claim 10 wherein the document finishing data includes at least one of color rendering, stapling, collation, medium size, medium stock, simplex, duplex, and n-up rendering.

12. The method of claim 9 wherein payment data corresponding to a specified payment method for rendering of the electronic document is initially received via the local interface.

13. The method of claim 9 wherein preliminary payment data corresponding to a specified payment method for rendering of the electronic document is received via the remote thin client interface.

14. The method of claim 13 wherein modified payment data corresponding to a modified form of payment for rendering of the electronic document is received via the local interface.
